(19) United States
(12) Patent Application Publication
(10) Pub. No.: US 2025/0271391 A1
(43) Pub. Date: Aug. 28, 2025

(54) SENSOR CAP FOR A SENSOR AND METHOD OF MANUFACTURING THE SENSOR CAP

(71) Applicant: Endress+Hauser Conducta GmbH+Co. KG, Gerlingen (DE)

(72) Inventor: Nora Schubert, Meißen (DE)

(21) Appl. No.: 19/054,316

(22) Filed: Feb. 14, 2025

(30) Foreign Application Priority Data
Feb. 27, 2024 (DE) 10 2024 105 481.6

(51) Int. Cl. G01N 27/404

(52) U.S. Cl. CPC G01N 27/404

(57) ABSTRACT

A sensor cap for an electrochemical sensor for determining the concentration of an analyte in a measurement medium, includes a main part, which extends along a first axis and has a first end, which has a first opening, and a second end, which is opposite the first end and has a second opening, wherein an electrolyte chamber extends between the first opening and the second opening and a connecting unit is formed at the second end in order to connect the sensor cap to a sensor body of the electrochemical sensor, a membrane unit having a first membrane element and a second membrane element, wherein the first membrane element is permeable to the analyte and the second membrane element comprises a material that is impermeable to the analyte, wherein the second membrane element has a through-hole.

### CROSS-REFERENCE TO RELATED APPLICATION

The present application is related to and claims the priority benefit of German Patent Application No. 10 2024 105 481.6, filed on Feb. 27, 2024, the entire contents of which are incorporated herein by reference.

### TECHNICAL FIELD

The present disclosure relates to a sensor cap for an electrochemical sensor, a sensor cap for an optochemical sensor, an electrochemical sensor, an optochemical sensor, a manufacturing method of the sensor cap for the electrochemical sensor, and a method of manufacturing the sensor cap for the optochemical sensor.

### BACKGROUND

In analytical measurement technology, for example, in the fields of water management, of environmental analysis, in industry, e.g., in food technology, biotechnology, and pharmaceutics, as well as for the most varied laboratory applications, measured variables, such as the pH, the conductivity, or even the concentration of analytes, such as ions or dissolved gases in a gaseous or liquid measurement medium, are of great importance. These measured variables can be detected and/or monitored, for example, by means of electrochemical sensors, such as potentiometric, amperometric, voltammetric, coulometric or optochemical sensors.

Electrochemical and optochemical sensors frequently comprise a membrane, which is brought into contact with a measurement medium, e.g., a measurement gas or a measurement liquid, in order to capture measured values during continuous measurement. Depending on whether the sensor is an electrochemical or optochemical sensor, the membrane serves a different function and is specifically designed for its use. In the case of electrochemical sensors, the membrane is often a porous layer, in particular one with pores or openings, which is at least partially permeable to the measurement medium or at least an analyte contained therein. In the case of optochemical sensors, for example, the membrane is often a thin film, which is used as a carrier material.

A property of these membranes is usually that the transport of substances through the membrane can take place in both directions, i.e., from the measurement medium to the interior of the sensor and vice versa. This makes it possible, for example, for the analyte to be detected by the sensor to migrate into the interior of the sensor, which is also desirable. However, with electrochemical sensors, for example, which have an electrolyte inside, components of the electrolyte can migrate from the measurement chamber of the sensor through the membrane into the surrounding medium. This results in the service life of the electrolyte being shortened. Consequently, the electrolyte of the sensor must be changed regularly, which increases the maintenance effort of the sensor.

### SUMMARY

It is therefore an object of the present disclosure to provide a sensor that is durable, reliable and accurate.

This object is achieved according to the present disclosure by a sensor cap for an electrochemical sensor for determining the concentration of an analyte in a measurement medium according to the present disclosure.

The sensor cap according to the present disclosure comprises:
a main part, which extends along a first axis and has a first end, which has a first opening, and a second end, which is opposite the first end and has a second opening, wherein an electrolyte chamber extends between the first opening and the second opening and a connecting unit is formed at the second end in order to connect the sensor cap to a sensor body of the electrochemical sensor,
a membrane unit having a first membrane element and a second membrane element,
wherein the first membrane element is permeable to the analyte and the second membrane element comprises a material that is impermeable to the analyte,
wherein the second membrane element has a through-hole, wherein the membrane unit is connected to the main part such that the first opening is closed by the membrane unit,
wherein the first membrane element and the second membrane element are welded to the main part.

The sensor cap according to the present disclosure makes it possible to reduce leaching of the electrolyte arranged in the electrolyte chamber of the sensor head, which increases the service life of the sensor.

According to one embodiment of the present disclosure, the first membrane element comprises a hydrophilic material, for example, polyethylene terephthalate (PET), and the second membrane element comprises a gas-tight material, for example, polyvinylidene fluoride (PVDF).

According to a further embodiment of the present disclosure, the main part has a positioning aid in the electrolyte chamber, and a spacer element is arranged between the membrane unit and the positioning aid, wherein the positioning aid holds the spacer element at a predetermined axial position.

According to one embodiment of the present disclosure, the main part has a pressure equalization opening, which opens into the electrolyte chamber and is closed by a valve unit.

According to one embodiment of the present disclosure, the main part comprises a plastics material and the membrane unit is ultrasonically welded to the main part.

The above-mentioned object is also achieved by an electrochemical sensor according to the present disclosure.

The electrochemical sensor according to the present disclosure has a sensor cap according to the present disclosure and a sensor body having an electrode unit, wherein the electrode unit has an electrode, and wherein the sensor cap is connected to the sensor body via a connecting unit and an electrolyte is arranged in the electrolyte chamber.

According to one embodiment of the present disclosure, the through-hole of the second membrane element has a predetermined first diameter and the electrode has a predetermined second diameter, wherein the first diameter and the second diameter are substantially identical.

The above-mentioned object is also achieved by a method for manufacturing a sensor cap according to the present disclosure.

The method according to the present disclosure comprises:
providing a main part and a membrane unit, wherein the main part extends along a first axis and has a first end, which has a first opening, and a second end, which is opposite the first end and has a second opening, wherein an electrolyte chamber extends between the first opening and the second opening and a connecting unit is formed at the second end in order to connect the sensor cap to a sensor body of the electrochemical sensor,
connecting the membrane unit and the main part so that the first membrane element and the second membrane element are connected to the main part and close the first opening, wherein the first membrane element and the second membrane element are simultaneously ultrasonically welded to the main part.

According to one embodiment of the present disclosure, the main part has a positioning aid in the electrolyte chamber and, prior to connecting the membrane unit and the main part, a spacer element is inserted into the electrolyte chamber so that the spacer element is held by the positioning aid.

The above-mentioned object is also achieved by a sensor cap for an optochemical sensor for determining the concentration of an analyte in a measurement medium according to the present disclosure.

The sensor cap according to the present disclosure comprises:
a main part, which extends along a first axis and has a first end and a second end opposite the first end,
wherein a window is formed at the first end and a connecting unit is formed at the second end in order to connect the sensor cap to a sensor body of the electrochemical sensor,
a membrane unit having a first membrane element and a second membrane element,
wherein the first membrane element is permeable to the analyte and the second membrane element comprises a material that comprises a luminescent substance,
wherein the membrane unit is connected to the main part such that the window is covered by the membrane unit,
wherein the first membrane element and the second membrane element are welded to the main part.

The above-mentioned object is also achieved by a method for manufacturing a sensor cap according to the present disclosure.

The method according to the present disclosure comprises:
providing a main part and a membrane unit, wherein the main part extends along a first axis and has a first end and a second end opposite the first end, wherein a window is formed at the first end,
connecting the membrane unit and the main part so that the first membrane element and the second membrane element are welded to the main part and the window is covered by the membrane unit.

The above-mentioned object is also achieved by an optochemical sensor according to the present disclosure.

The optochemical sensor according to the present disclosure has a sensor cap according to the present disclosure and a sensor body, wherein the sensor cap is connected to the sensor body.

### BRIEF DESCRIPTION OF THE DRAWINGS

The present disclosure is explained in more detail with reference to the following figures.

FIG. 1 shows an embodiment of an electrochemical sensor according to the present disclosure;

FIG. 2 shows an embodiment of a sensor cap according to the present disclosure for the electrochemical sensor of FIG. 1;

FIG. 3 shows another embodiment of an optochemical sensor according to the present disclosure; and

FIG. 4 shows a further embodiment of a sensor cap according to the present disclosure for the optochemical sensor of FIG. 3.

### DETAILED DESCRIPTION

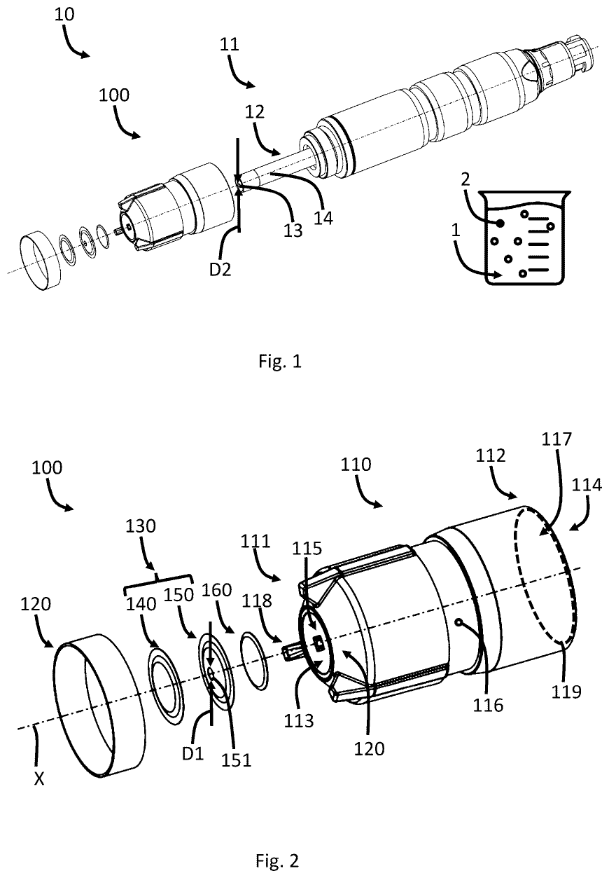

FIG. 1 shows an electrochemical sensor 10 according to the present disclosure having a sensor cap 100 and a sensor body 11. The sensor body 11 has an electrode unit 12 having an electrode 13. The electrode unit 12 comprises a counter-electrode 14. The counter-electrode 14 is formed, for example, as a sleeve. The electrode 13 may be a cathode and the counter-electrode 14 an anode. The sensor cap 100 is detachably connected to the sensor body 11. The electrochemical sensor 10 is suitable for detecting an analyte 2 in a measurement medium 1, for example for determining the concentration of the analyte 2 in the measurement medium 1. The analyte 2, for example, is free chlorine or bound chlorine.

FIG. 2 shows the sensor cap 100 in detail in an exploded view. The sensor cap 100 comprises a main part 110, an electrode 120 and a membrane unit 130.

The main part 110 extends along a first axis X and has a first end 111 and a second end 112 opposite the first end 111. A first opening 113 is formed at the first end 111. A second opening 114 is formed at the second end 112. An electrolyte chamber 117 extends between the first opening 113 and the second opening 114. The electrolyte chamber 117 is formed, for example, by the entire interior of the main part 110. The electrolyte chamber 117 can be filled with electrolyte from the second opening 114.

The main part 110 comprises plastic, for example PVDF, so that ultrasonic welding to the membrane unit 130 is possible. A positioning aid 115 is preferably formed in the electrolyte chamber 117 in order to position a spacer element 160 relative to an electrode head (not shown) of the electrode 120 in the electrolyte chamber 117. Preferably, the main part 110 has a plurality of, for example three, positioning aids 115. The positioning aids 115 are preferably arranged around the first axis X in the main part 110.

An electrolyte is stored in the electrolyte chamber 117.

The main part 110 preferably has a pressure equalization opening 116, which opens into the electrolyte chamber 117 and is closed by a valve unit 120. The valve unit 120 is, for example, an elastic ring or an elastic band, which is stretched around the main part 110 over the pressure equalization opening 116 (see FIG. 2). In order to prevent the elastic band from slipping axially, the main part 110 preferably has an axially circumferential recess that is complementary to the elastic band.

At the first end 111, the main part 110 preferably has one or more, in particular three, supports 118, which preferably extend in parallel with the first axis X so that the electrochemical sensor 10 can be placed on a flat surface with the aid of the three supports 118, without the membrane unit 130 touching the flat surface. This makes it possible for simple and safe filling of the electrolyte chamber 117 through the second opening 114 when the sensor cap 100 is separated from the sensor body 11. The support 118 thus allows the sensor cap 100 to be placed stably on a surface.

At the second end 112, a connecting unit 119 is formed in order to connect the sensor cap 100 to the sensor body 11 of the electrochemical sensor 10. The connecting unit 119 is designed, for example, as a thread that is complementary to a thread on the sensor body (not shown).

The membrane unit 130 is fastened to the main part 110 such that the membrane unit 130 closes the first opening 113. The membrane unit 130 has a first membrane element 140 and a second membrane element 150. The membrane unit 130 is welded to the main part 110.

The first membrane element 140 is permeable to the analyte 2 and the second membrane element 150 comprises a material that is impermeable to the analyte 2. The first membrane element 140 is, for example, a sensory hydrophilic membrane. According to an alternative embodiment, it is also possible that the first membrane element 140 has hydrophobic properties, which leads to a lower transport of substances through the first membrane element 140. The first membrane element 140 comprises a hydrophilic material, for example, PET, and the second membrane element 150 comprises a gas-tight material, for example, PVDF. The first membrane element 140 and the second membrane element 150 preferably have the same diameter. The first membrane element 140 and the second membrane element 150 are connected to the main part 110 by means of ultrasonic welding.

The second membrane element 150 has a through-hole 151. The through-hole 151 is preferably arranged centrally in the second membrane element 150. The through-hole 151 has a predetermined first diameter D1 and the electrode 13 has a predetermined second diameter D2. The first diameter D1 and the second diameter D2 are preferably substantially identical. The electrode 13 is preferably arranged axially aligned with the through-hole 151, i.e., on the first axis X.

According to an embodiment not shown, it is also possible to arrange a third membrane element in the membrane unit 130. The third membrane element is, for example, a support grid or a carrier material with a mediator for an intermediate chemical reaction with the analyte 2.

A positioning aid 115 is preferably formed in the electrolyte chamber 117. In the electrolyte chamber 117, a spacer element 160 is preferably arranged between the membrane unit 130 and the positioning aid 115. The positioning aid 115 makes it possible for the spacer element 160 to be held at a predetermined axial position. The spacer element 160 is, for example, a grid or a porous element. The grid is, for example, made of polyester. The spacer element 160 has a predetermined thickness and is in contact with the membrane unit 130, preferably with the second membrane element 150, and with the electrode 13 when the sensor cap 100 is connected to the sensor body 11, so that the predetermined thickness of the spacer element 160 defines the distance of the electrode 13 to the membrane unit 130. This makes it possible to ensure a predetermined diffusion path between the electrode 13, which is preferably used as a cathode, and the membrane unit 130. This in turn ensures maximum accuracy for the measurements performed with the electrochemical sensor 10, for example, the so-called slope of the electrochemical sensor 10.

The membrane unit 130 is connected to the main part 110 such that the electrolyte chamber 117 is closed by the membrane unit 130. The second membrane element 150 is arranged between the first membrane element 140 and the main part 110 such that the electrode 13 is arranged at the through-hole 151. The first membrane element 140 and the second membrane element 150 are jointly connected to the main part 110 by ultrasonic welding. The membrane unit 130 is preferably welded circumferentially at its edge region to the main part 110. The main part 110 preferably has a so-called concentrator formed at the first end 111 and running about the first axis X (not shown).

The following describes a method for manufacturing the sensor cap 100 described above.

Initially, the main part 110 and the membrane unit 130 are provided.

Next, the membrane unit 130 and the main part 110 are connected so that the first membrane element 140 and the second membrane element 150 are simultaneously connected to the main part 110 and close the first opening 113. The connection is carried out by ultrasonic welding. When welding the membrane unit 130, the first membrane element 140 and the second membrane element 150 are welded to the main part 110 at the same time. For this purpose, the first membrane element 140 and the second membrane element 150 are placed on top of each other and jointly welded to the main part 110. It is advantageous if the first membrane element 140 and the second membrane element 150 have the same diameter.

Preferably, the membrane unit 130 is welded circumferentially in its edge region.

Prior to connecting the membrane unit 130 and the main part 110, the spacer element 160 is preferably inserted onto the positioning aid 115 in the electrolyte chamber 117.

In the following, an alternative embodiment of the sensor cap in the application case of an optochemical sensor 20 is described.

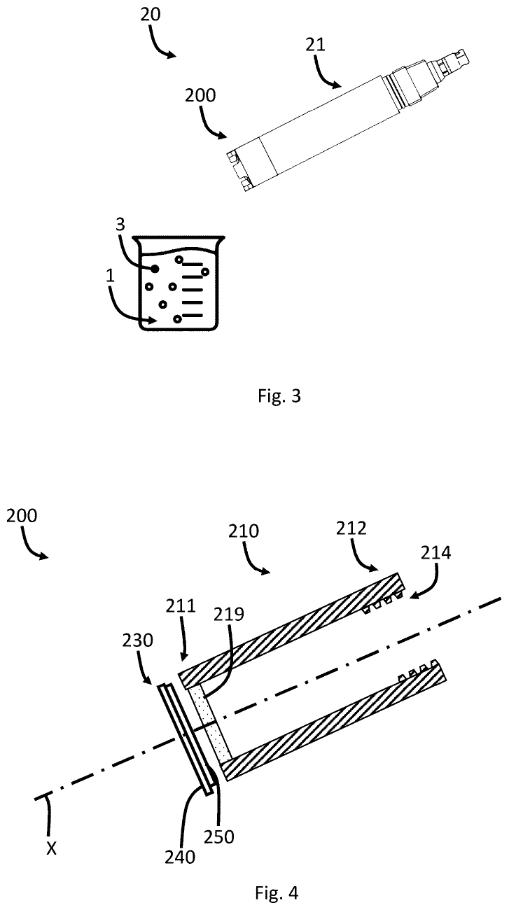

FIG. 3 shows an optochemical sensor 20 having a sensor cap 200 and a sensor body 21 for detecting an analyte 3, such as oxygen. The sensor cap 200 is detachably connected to the sensor body 21.

FIG. 4 shows an enlarged representation of the sensor cap 200.

The sensor cap 200 comprises a main part 210 and a membrane unit 230.

The main part 210 extends along the first axis X and has a first end 211 and a second end 212 opposite the first end 211. A window 219 is formed at the first end 211 and a connecting unit 214 is formed at the second end 212 in order to connect the sensor cap 200 to a sensor body 21 of the optochemical sensor 20. As shown in FIG. 4, the connecting unit 214 is designed, for example, as an internal thread that is complementary to an external thread (not shown) on the sensor body.

The membrane unit 230 has a first membrane element 240 and a second membrane element 250. The first membrane element 240 is permeable to the analyte 3 and at the same time, for example, hydrophilic. The second membrane element 250 comprises a material that comprises a luminescent substance. The second membrane element 250 is also referred to as a functional layer.

The membrane unit 230 is connected to the main part 210 such that the window is covered by the membrane unit 230.

The second membrane element 250 is arranged between the first membrane element 240 and the main part 210.

Hereinafter, the method of manufacturing the sensor cap 200 is described.

Initially, the main part 210 and the membrane unit 230 are provided.

Then, the membrane unit 230 and the main part 210 are connected so that the first membrane element 240 and the second membrane element 250 are jointly connected to the main part 210 and the window 219 is covered by the membrane unit 230. The connection is carried out by an ultrasonic welding process, as in the first embodiment described above.

1. A sensor cap for an electrochemical sensor for determining a concentration of an analyte in a measurement medium, the sensor cap comprising:
a main part, which extends along a first axis and has a first end, which includes a first opening, and a second end, which is opposite the first end and includes a second opening, wherein an electrolyte chamber extends between the first opening and the second opening, and wherein a connector is formed at the second end, which is configured to connect the sensor cap to a sensor body of the electrochemical sensor,
a membrane unit including a first membrane element and a second membrane element, wherein the first membrane element is permeable to the analyte and the second membrane element comprises a material that is impermeable to the analyte,
wherein the second membrane element includes a through-hole,
wherein the membrane unit is connected to the main part such that the first opening is closed by the membrane unit, and
wherein the first membrane element and the second membrane element are welded to the main part.

2. The sensor cap according to claim 1,
wherein the first membrane element comprises a hydrophilic material, and the second membrane element comprises a gas-tight material.

3. The sensor cap according to claim 1, wherein the main part includes a positioning aid in the electrolyte chamber, and a spacer element is arranged between the membrane unit and the positioning aid, wherein the positioning aid holds the spacer element at a predetermined axial position.

4. The sensor cap according to claim 1, wherein the main part includes a pressure equalization opening that opens into the electrolyte chamber and is closed by a valve unit.

5. The sensor cap according to claim 1, wherein the main part comprises a plastics material, and wherein the membrane unit is ultrasonically welded to the main part.

6. An electrochemical sensor comprising a sensor cap according to claim 1, wherein the sensor body includes an electrode unit, wherein the electrode unit includes an electrode, and wherein the sensor cap is connected to the sensor body via the connector, and an electrolyte is disposed in the electrolyte chamber.

7. The electrochemical sensor according to claim 6, wherein the through-hole of the second membrane element has a predetermined first diameter, and the electrode has a predetermined second diameter, wherein the first diameter and the second diameter are substantially identical.

8. A method for manufacturing the sensor cap according to claim 1, the method comprising:
providing the main part and the membrane unit; and,
connecting the membrane unit and the main part such that the first membrane element and the second membrane element are connected to the main part and close the first opening, wherein the first membrane element and the second membrane element are simultaneously ultrasonically welded to the main part.

9. The method according to claim 8, wherein the main part includes a positioning aid in the electrolyte chamber and, prior to connecting the membrane unit and the main part, a spacer element is inserted into the electrolyte chamber such that the spacer element is held by the positioning aid.

10. A sensor cap for an optochemical sensor for determining a concentration of an analyte in a measurement medium, the sensor cap comprising:
a main part, which extends along a first axis and has a first end and a second end opposite the first end, wherein a window is formed at the first end and a connecting unit is formed at the second end in order to connect the sensor cap to a sensor body of the electrochemical sensor,
a membrane unit having a first membrane element and a second membrane element, wherein the first membrane element is permeable to the analyte and the second membrane element comprises a material that comprises a luminescent substance, wherein the membrane unit is connected to the main part such that the window is covered by the membrane unit,
wherein the first membrane element and the second membrane element are welded to the main part.

11. A method for manufacturing the sensor cap according to claim 10, the method comprising:
providing the main part and the membrane unit, and
connecting the membrane unit and the main part such that the first membrane element and the second membrane element are welded to the main part and the window is covered by the membrane unit.

12. An optochemical sensor comprising the sensor cap according to claim 10 and a sensor body, wherein the sensor cap is connected to the sensor body.

13. The sensor cap according to claim 1, wherein the first membrane element comprises PET, and the second membrane element comprises PVDF.
